(19) United States
(12) Patent Application Publication
(10) Pub. No.: US 2009/0003157 A1
(43) Pub. Date: Jan. 1, 2009

(54) Information Recording Medium, and Information Reproducing Apparatus and Method

(75) Inventor: Kazuo Kuroda, Saitama (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 10/588,764

(22) PCT Filed: Feb. 7, 2005
(86) PCT No.: PCT/JP2005/001754

§ 371 Date: Aug. 8, 2006

(30) Foreign Application Priority Data
Feb. 9, 2004 (JP) 2004-032126

(51) Int. Cl. G11B 20/10; G11B 7/26

(52) U.S. Cl. 369/47.15; 369/272.1; G9B/7.194; G9B/20.009

(57) ABSTRACT

An information recording medium includes a reproduction-dedicated area (160) where first recording information (60-1, etc.) is recorded in such a manner that its reproduction will not be disabled when it is reproduced, and a number-of-reproductions limit area (150) where second recording information (50-1, etc.) is recorded in such a manner that its reproduction will be disabled when a predetermined number of reproductions are performed. The second recording information (50-1, etc.) is correlated with the first recording information (60-1, etc.).

### TECHNICAL FIELD

The present invention relates to an information recording medium, such as an optical disc, on which recording and reproduction can be performed by irradiating it with laser light, for example, and an information reproducing apparatus for and an information reproducing method of performing the reproduction on such an information recording medium.

### BACKGROUND ART

In this type of information recording medium, in order to prevent that information is mistakenly deleted during reproduction by irradiating laser light, a range of power (i.e. energy or light intensity) of laser light in which the information can be reproduced (hereinafter referred to as a “reproduction power range” in this application, as occasion demands) is set lower than a range of laser light power in which the recorded information can be deleted (hereinafter referred to as a “deleting power range” in this application, as occasion demands). Moreover, a range of laser light power in which the information can be recorded (hereinafter referred to as a “recording power range” in this application, as occasion demands) is set higher than the deleting power range. The reproduction power range, the deleting power range, and the recording power range are unique to a recording layer, and generally, this type of setting is obtained depending on the material and the film thickness of the recording layer. Then, in accordance with the recording layer, an information recording/reproducing apparatus is constructed to irradiate the laser for recording with a much higher power than that of the laser for reproduction.

On the other hand, there is also suggested a technology of deleting the information, by deteriorating the recording layer having the above-mentioned character by irradiating the laser for reproduction a plurality of times, in order to limit the number of times of the information reproduction. For example, a patent document/discloses a technology of deleting the recorded information, by increasing the power of the laser for reproduction of the information recording/reproducing apparatus, up to near the power of deleting the information data on the information recording medium, and by irradiating the laser for reproduction a certain number of times controlled.

Moreover, there is also suggested a hybrid type optical disc having a combination of a recordable recording area similar to that of a recordable type optical disc, such as a CD-R and a DVD-R, and a reproduce-only recording area similar to that of a reproduce-only optical disc, such as a CD-ROM and a DVD-ROM, located in an area nearer the outer circumference and an area nearer the inner circumference of one optical disc, respectively.

Patent document 1: Japanese Patent Application Laying Open NO. 2001-331942
Patent document 2: Japanese Patent Application Laying Open NO. 2001-67731

### DISCLOSURE OF INVENTION

### Subject to be Solved by the Invention

However, in the patent document 1, the reproduction can be actually performed with the power in which the recording cannot be performed, only by bringing the reproduction power close to the recording power, so that there is a deletion avoiding device. Moreover, according to the above-mentioned hybrid type optical disc, in a combination of the technology of limiting the number of times of reproduction, there is an avoiding device for the same reason.

On the other hand, even if there is a hybrid disc which can perform the deletion with the reproduction power, this is still technically difficult. That is because although reproduction of which record information is completed can be clarified from the fact that the reproduction cannot be performed, with regard to the record information in which the number of times of reproduction is limited, by combining the above-mentioned hybrid type optical disc and the technology of limiting the number of times of reproduction, there is such a technical problem that actually there is no way to know reproduction of which record information is not completed yet, as described below.

If trying to know the reproduction of which record information is not completed yet by actually irradiating the laser light, the record information is deleted by the irradiation of the laser light in order to know that. In contrast, with regard to the record information in which the number of times of reproduction is not limited, there is no change even after the reproduction, so that there is such a technical problem that there is no way to detect the reproduction of which record information is completed, from the recording state of the record information.

In order to solve the above-mentioned problem, it is therefore an object of the present invention to provide an information recording medium in which the number of times of reproduction can be limited, and it can be relatively easily detected whether or not the reproduction of the record information is completed, and an information reproducing apparatus for and an information reproducing method of performing the reproduction on the information recording medium.

### Means for Solving the Subject

In order to solve the above-mentioned object, the information recording medium according to claim 1 of the present invention is an information recording medium provided with: a reproduce-only area in which first record information is recorded not to be unreproducible along with a reproduction operation; and a number-of-times-of-reproduction limit area in which second record information is recorded to be unreproducible along with a predetermined number of times of reproduction operations, the second record information being associated with the first record information.

In order to solve the above-mentioned object, the information reproducing apparatus according to claim 5 of the present invention is An information reproducing apparatus for reproducing the first and second record information recorded on the information recording medium according to claim 1, the information reproducing apparatus provided with: a reproducing device for reproducing the first and second record information; a controlling device for controlling the reproducing device to reproduce the second record information recorded in the number-of-times-of-reproduction limit area; and a judging device for detecting whether or not there is the second record information recorded in the number-of-times-of-reproduction limit area and for judging whether or not reproduction of the first record information corresponding to the second record information is completed.

In order to solve the above-mentioned object, the information reproducing method according to claim 11 of the present invention is an information reproducing method in an information reproducing apparatus provided with: a reproducing device for reproducing the first and second record information recorded on the information recording medium according to claim 1, the information reproducing method provided with: a controlling process of controlling the reproducing device to reproduce the second record information corresponding to the first record information after reproduction of the first record information; and a judging process of detecting whether or not there is the second record information recorded in the number-of-times-of-reproduction limit area and of judging whether or not the reproduction of the first record information corresponding to the second record information is completed.

These effects and other advantages of the present invention become more apparent from the following embodiments.

### BRIEF DESCRIPTION OF DRAWINGS

FIG. 1 shows the basic structure of an optical disc in an example of the information recording medium of the present invention, wherein an upper part is a schematic plan view showing the optical disc having a plurality of recording areas and a lower part corresponding thereto is a schematic conceptual view showing a recording area structure in the radial direction.

FIG. 2 is a graph showing one specific example of a reproduction power range, a deleting power range, and a recording power range of a recording layer, in a number-of-times-of-reproduction limit area of the optical disc in the example of the present invention.

FIG. 3 is a schematic enlarged perspective view in which one portion of the optical disc in the example of the present invention is viewed from the recording surface side of the optical disc.

FIG. 4 is a schematic structure diagram showing the structure of the recording areas, a reproduce-only area, and the number-of-times-of-reproduction limit area of the optical disc in the example of the present invention.

FIG. 5 is an appearance perspective view showing a direction of a track count on the recording surface of the optical disc in the example of the present invention.

FIG. 6 is a conceptual view showing the state of second record information recorded in the number-of-times-of-reproduction limit area in another example of the present invention.

FIG. 7 is a block diagram showing the entire structure of an information reproducing apparatus for the optical disc, in an example of the present invention.

FIG. 8 is a flowchart showing a reproduction operation of the optical disc by the information reproducing apparatus in the example of the present invention.

### DESCRIPTION OF REFERENCE CODES

1 . . . Center hole,
10 . . . Track,
11 . . . ECC block,
20 . . . Record mark,
30 . . . Recording layer,
31 . . . Reflective layer,
32 . . . Substrate,
33 . . . Protective layer,
100 . . . Optical disc,
101 . . . Lead-in area,
102 . . . Data zone,
102A . . . File management information recording area,
103 . . . Lead-out area,
50-1 to 50-N . . . 1st band to Nth band,
60-1 to 60-N . . . 1st data to Nth data,
150 . . . Number-of-times-of-reproduction limit area,
150-1 to 150-N . . . 1st band zone to Nth band zone,
160 . . . Reproduce-only area,
160-1 to 160-N . . . 1st data zone to N data zone,
200 . . . Information reproducing apparatus,
202 . . . Optical pickup,
203 . . . Spindle motor,
204 . . . Head amplifier,
210 . . . Sum generation circuit,
211 . . . Pit data modulation circuit,
212 . . . Pit data correction circuit,
213 . . . Buffer,
214 . . . Interface,
220 . . . Push-pull signal generation circuit,
221 . . . Low pass filter,
222 . . . Servo unit,
300 . . . CPU,
G . . . Groove track,
L . . . Land track,
EA . . . Readable embossed area,
EP . . . Embossed pit,
ES . . . Embossed space

### BEST MODE FOR CARRYING OUT THE INVENTION

### Embodiment of Information Recording Medium

Hereinafter, the information recording medium in an embodiment of the present invention will be explained.

An embodiment of the information recording medium of the present invention is an information recording medium provided with: a reproduce-only area in which first record information is recorded not to be unreproducible along with a reproduction operation; and a number-of-times-of-reproduction limit area in which second record information is recorded to be unreproducible along with a predetermined number of times of reproduction operations, the second record information being associated with the first record information.

According to the embodiment of the information recording medium of the present invention, the second record information recorded in the number-of-times-of-reproduction limit area can be reproduced the predetermined number of times, which is once or a plurality of times, by an information reproducing apparatus, such as an optical disc player, for example. Before or after this, or in parallel with this, the first record information recorded in the reproduce-only area can be also reproduced. After that, after the predetermined number of times of reproduction, the second record information is deleted, for example, along with the predetermined number of times of reproduction operation, so that the second record information can be no longer reproduced.

On the other hand, the first record information may remain reproducible. Alternatively, by maintaining the second record information as information necessary to reproduce the first record information, it is possible to set the first record information to be unreproducible. As described above, it is possible to relatively easily limit the number of times of reproduction of the second record information and the number of times of reproduction of the first and second record information. Moreover, if the first and second record information are recorded such that the second record information is necessary to reproduce the first record information, it is possible to end up restoring the first and second record information in a reproducible condition, because the first record information is maintained as it is when only the second record information is recorded again, after the first record information cannot be reproduced due to the predetermined number of times of reproduction of the second record information. In this manner, the information recording medium can be reused. Incidentally, it may be constructed such that in the number-of-times-of-reproduction limit area, the second record information can be reproduced once, as the predetermined number of times. Alternatively, it may be constructed such that it can be reproduced a plurality of times, such as twice, three times, and four times, as the predetermined number of times. Moreover, the number of times of reproduction is strictly limited, such as only once and only twice, or limited in a certain degree of range of the number of times, such as about five times and about ten times. In addition, as the first record information, contents with a large information data amount, such as a movie, can be recorded at once into the reproduce-only area by a stampa. Thus, it is possible to reduce a preparation time per one information recording medium, and thus it is also possible to improve its productivity.

In the embodiment, particularly, the second information is associated with the first record information. For example, each of a plurality of second record information is associated with respective one of a plurality of first record information.

Such association may be logical association, or physical association. The “logical association” herein is to associate the reproduce-only area in which the first record information is recorded, with the number-of-times-of-reproduction limit area in which the second record information corresponding to the first record information is recorded, on the basis of a logical address allocated or assigned in the both areas, in the reproduction and the recording. Specifically, a table on which identification numbers of a plurality of first record information and the addresses of a plurality of reproduce-only areas are registered, or the like, are registered or recorded in management information or the like. On the other hand, a table on which identification numbers of a plurality of second record information and the addresses of a plurality of number-of-times-of-reproduction limit areas are registered, or the like, are registered or recorded in the same management information or the like. Thus, each of the plurality of second record information can be logically associated with respective one of the plurality of first record information. Alternatively, a table on which identification numbers of the plurality of reproduce-only areas and the addresses thereof are registered, or the like, are registered or recorded in the management information or the like. On the other hand, a table on which identification numbers of the plurality of number-of-times-of-reproduction limit areas and the addresses thereof are registered, or the like, are registered or recorded in the management information or the like. Thus, each of the plurality of number-of-times-of-reproduction limit areas in which the plurality of second record information are respectively recorded can be logically associated with respective one of the plurality of reproduce-only areas in which the plurality of first record information are respectively recorded. On the other hand, the physical association herein is to associate the reproduce-only area in which the first record information is recorded, with the number-of-times-of-reproduction limit area in which the second record information corresponding to the first record information is recorded, on the basis of the physical structure of the recording areas, in the reproduction and the recording. Specifically, if the number-of-times-of-reproduction limit area is specified in accordance with a certain rule, such as in front of the start portion or behind the end portion of an Nth reproduce-only area is an Nth number-of-times-of-reproduction limit area, and in front of the start portion or behind the end portion of an N+1th reproduce-only area is an N+1th number-of-times-of-reproduction limit area, then, it is possible to specify the reproduce-only area physically corresponding to the number-of-times-of-reproduction limit area. Thus, each of the plurality of second record information is physically associated with respective one of the plurality of first record information.

In any case of the above-mentioned logical or physical association, whether or not the second record information is associated with the first record information is registered in the management information or a memory in an information recording apparatus, for example, and it is known upon the reproduction of the first record information, for example.

Moreover, in the embodiment, the second record information may include a plurality of smallest information units which can be reproduced and deleted by a discontinuous reproduction operation. The “smallest information unit” herein indicates a smallest size of constituent unit of the second record information which can be reproduced and deleted. More specifically, if the reproduction is performed by a small amount of each second record information, i.e. at least by the smallest information unit, every time the status of reproduction is judged, then, the judgment can be performed. Therefore, after the judgment, one or more of the smallest information units remain in each second record information. Then, it can be estimated how many times of loading of the information recording medium is necessary to complete the reproduction, in accordance with the content of each first record information or the like, such as content of a game, for example. Thus, if each second record information is recorded by the smallest information units sufficiently over the number of times of loading, the situation that each second record information is completely deleted and used up does not occur until the end of life of the information recording medium in a range of number of times under normal or ordinary use, assumed. Namely, in practice, it is possible to judge the reproduction status until the end, by using each second record information. Incidentally, if all the second record information is reproduced in an abnormal way to use, it is judged that the reproduction is completed on the information recording medium, but there is not a particular hindrance.

By virtue of the above-mentioned construction, upon the reproduction of the information recording medium, if the reproduction of the first record information is completed, the second record information associated with the first record information cannot be reproduced along with the continuous reproduction operation, for example. Namely, the second record information is reproduced and simultaneously deleted. For example, if the reproduction of the 1st first record information (i.e., 1st of the first record information) is completed, which is the content data of a first stage of a home-use game for a personal computer, the 1st second record information (i.e., 1st of the second record information) recorded in the number-of-times-of-reproduction limit area, logically or physically associated with the 1st first record information, cannot be reproduced along with the continuous reproduction operation, for example.

In particular, the second record information includes the plurality of smallest information units which can be reproduced and deleted by the discontinuous reproduction operation. Thus, at the time of continuous reproduction or next time the disc is inserted or loaded, because only a small amount of the 1st second record information recorded in the number-of-times-of-reproduction limit area, i.e. the smallest information unit, cannot be reproduced by the discontinuous reproduction operation, such as track jump or scanning, it is detected that the 1st second record information does not exist. By this, it is possible to judge that the reproduction of the 1st first record information, which is the content data of the first stage, for example, is completed.

Moreover, it is detected that the 2nd second record information exists, which is recorded in the number-of-times-of-reproduction limit area, by reproducing the smallest information unit of the 2nd second record information by the discontinuous reproduction operation, such as track jump, for example. By this, it is possible to judge that the reproduction of the 2nd first record information, which is the content data of a second stage, for example, recorded in the reproduce-only area, is not completed yet.

Then, it turns out that it is necessary to start the reproduction from the 2nd first record information, which is the content data of the second stage, for example. In the same manner, the reproduction process can be performed up to the Nth first record information which is the content data of the Nth stage, for example.

As described above, the presence or absence of each second record information detected upon the reproduction of the information recording medium, functions as a binarized flag for indicating whether or not the reproduction of each first record information associated with each second record information is completed. Thus, while the number of times of reproduction is limited, it is possible to relatively easily detect or judge whether or not the reproduction of the first record information is completed, on the information reproducing apparatus. Therefore, a user can certainly or easily judge until which level or which stage the reproduction of the content data is completed, for example.

Moreover, in the embodiment, particularly, the reproduce-only areas in which the 1st to the Nth first record information are respectively recorded, and the number-of-times-of-reproduction limit areas in which the 1st to the Nth second record information are respectively recorded, may be alternately located from the inner to the outer circumferential side, basically, in accordance with the order of reproduction of the 1st to the Nth first record information, for example, on the basis of temporal or timing locality/spatial locality in the operation of an optical pickup or the like. Therefore, the Nth first record information and Nth second record information which have a high possibility of noncompletion until the end of the completion of reproduction of the information recording medium, and the data closer thereto such as N−1th or N−2th, have less opportunities of irradiating the laser for reproduction by the track jump or scanning, to judge whether or not the stage is completed. Thus, it is possible to prevent such a situation that the Nth first record information and Nth second record information, which have a high possibility of noncompletion until the end, and data closer thereto, are unnecessarily irradiated with the laser for reproduction, by which the Nth first record information and Nth second record information, and data closer thereto are used up as flags, before the completion of reproduction of the information recording medium. Nth first record information and Nth second record information can be arbitrarily disposed, according to the application and purpose of the 1st to the Nth first record information.

In addition, according to the embodiment, a relatively large amount of first record information is maintained as it is. Thus, after only by once judging the completion of reproduction and judging that the reproduction cannot be performed, recording again a relatively small amount of second record information, it is possible to normally reproduce again the first record information, such as content data, recorded on the information recording medium, with a normal optical disc player or optical disc recorder, at each hierarchical level. Thus, it is possible to reuse the information recording medium as a whole, extremely efficiently.

In one aspect of the embodiment of the information recording medium of the present invention, the information recording medium comprises only a plurality of number-of-times-of-reproduction limit areas, and the reproduce-only area is disposed between the plurality of number-of-times-of-reproduction limit areas.

According to this aspect, the second record information is recorded in at least one of the plurality of number-of-times-of-reproduction limit areas, divided by the reproduce-only area. Thus, in accordance with the order of logical reproduction of the first record information recorded in the reproduce-only area, it is possible to reproduce and delete the second record information recorded in at least one of the plurality of number-of-times-of-reproduction limit areas.

Consequently, it is possible to relatively easily know whether or not the reproduction of the first record information recorded in the reproduce-only area is completed.

In another aspect of the embodiment of the information recording medium of the present invention, information which indicates association of the second record information and the first record information is recorded in the reproduce-only area.

According to this, the information, such as a pointer, for example, which indicates association of the second record information and the first record information is recorded in the reproduce-only area, as at least one portion of the first record information. Thus, at the same time, or before or after the first record information is reproduced by the information reproducing apparatus, the address or the like of the second record information corresponding to the first record information, is known.

Consequently, as compared to a case where the information which indicates the association is collectively recorded in the management information or the like, it is possible to associate the first record information with the second record information, more easily and more quickly, upon the reproduction of the information recording medium.

In another aspect of the embodiment of the information recording medium of the present invention, the second record information includes content information which is reproduced after reproduction of the first record information.

According to this aspect, the second record information includes the content information, which indicates at least one of an image and music, for example, instead of dummy information, such as “Null” or “0”, for example, which indicates that there is the second record information. Thus, as compared to a case where the content information is recorded in the first record information or the like, for example, the second record information can be reproduced and simultaneously deleted, so that it is possible to save time and save the recording areas.

(Embodiment of Information Reproducing Apparatus)

Hereinafter, the information reproducing apparatus in an embodiment of the present invention will be explained.

An embodiment of the information recording medium of the present invention is an information reproducing apparatus for reproducing the first and second record information recorded on the above-mentioned information recording medium of the present invention (including its various aspects), the information reproducing apparatus provided with: a reproducing device for reproducing the first and second record information; a controlling device for controlling the reproducing device to reproduce the second record information associated with the first record information after the reproduction of the first record information; and a judging device for detecting whether or not there is the second record information recorded in the number-of-times-of-reproduction limit area and for judging whether or not reproduction of the first record information corresponding to the second record information is completed.

According to the embodiment of the information recording medium of the present invention, upon the operation thereof, the management information is read by the reproducing device, constructed from a processor, a demodulator, an optical pickup, or the like, before the actual reproduction operation, from a management information recording area of the information recording medium, for example. Then, preferably, the read management information may be stored into a processor, a memory, or the like.

Then, the first record information, for example, one of the plurality of first record information, more specifically, the 1st first record information (i.e., 1st of the first record information), which is the content data of the first stage of a home-use game for a personal computer, is reproduced by the reproducing device.

Then, if the reproduction of the 1st first record information is completed by the reproducing device, the 1st second record information (i.e., 1st of the second record information) logically or physically associated with the 1st first record information cannot be reproduced, i.e. reproduced and simultaneously deleted, along with the continuous reproduction operation, under the control of the controlling device.

Then, at the time of continuous reproduction or next time the disc is inserted or loaded, because only a small amount of the 1st second record information recorded in the number-of-times-of-reproduction limit area, i.e. the smallest information unit, cannot be reproduced by the reproducing device for performing track jump or scanning or the like, it is detected that the 1st second record information does not exist, under the control of the judging device. By this, it is possible to judge that the reproduction of the 1st first record information reproduced in the reproduce-only area is completed.

Moreover, under the control of the judging device, it is detected that the 2nd second record information exists, by that the smallest information unit of, e.g., the 2nd second record information recorded in the number-of-times-of-reproduction limit area can be reproduced and simultaneously deleted by the reproducing device. By this, it is possible to judge that the reproduction of the 2nd first record information, which is the content data of the second stage, for example, recorded in the reproduce-only area, is not completed yet.

Then, on the basis of the judgment results, it turns out that it is necessary to start the reproduction from the 2nd first record information, which is the content data of the second stage, for example, by using the reproducing device. In the same manner, the reproduction process can be performed up to the Nth first record information which is the content data of the Nth stage, for example. As described above, with regard to the 2nd second record information, even after the reproduction and judgment related to one smallest information unit out of the second record information, the other smallest information units are still not deleted and recorded in a reproducible condition for next time.

Consequently, the information reproducing apparatus of the present invention can detect the presence or absence of each second record information, upon the reproduction of the information recording medium, which is associated with each first record information and which functions as a binarized flag for indicating whether or not the reproduction of each first record information is completed. Thus, while limiting the number of times of reproduction, the information reproducing apparatus can relatively easily detect or judge whether or not the reproduction of the first record information is completed. Therefore, a user can certainly or easily judge until which level or which stage the reproduction of the content data is completed, for example.

In one aspect of the embodiment of the information reproducing apparatus of the present invention, the judging device controls the reproducing device to displace laser for reproduction in a direction of crossing a record track in the number-of-times-of-reproduction limit area, and detects whether or not there is the second record information, on the basis of a reproduction signal obtained from the reproducing device within a time length in which the laser for reproduction is displaced.

According to this aspect, under the control of the judging device, the reproducing device irradiates the laser for reproduction while it is displaced in the radial direction of a disc-shaped information recording medium, for example. Thus, the judging device can detect whether or not there is the second record information, more easily, on the basis of the reproduction signal obtained from the reproducing device.

In another aspect of the embodiment of the information reproducing apparatus of the present invention, the judging device detects whether or not there is the second record information, on the basis of the number of the record tracks crossed when the reproducing device is displaced.

According to this aspect, the judging device can detect whether or not there is the second record information, with higher accuracy, on the basis of the number of the record tracks crossed when the reproducing device is displaced.

Specifically, under the control of the judging device, the reproducing device irradiates the laser for reproduction in the radial direction of the disc-shaped information recording medium, in the number-of-times-of-reproduction limit area, to thereby measure the number of the record tracks. More specifically, at first, the record track is constructed from a row of record marks, formed by a phase change in the recording layer, in accordance with the second record information, for example. By irradiating the laser for reproduction not along the normal direction of the record track, but in a direction of crossing the record track perpendicularly, i.e. in the radial direction of the disc-shaped information recording medium, the number of the record tracks in the number-of-times-of-reproduction limit area is measured. Incidentally, one example of the above-mentioned “smallest information unit” is constructed from a small amount of second record information recorded in a micro domain in the number-of-times-of-reproduction limit area which is irradiated with the laser for reproduction in the direction of crossing the record track perpendicularly, i.e. in the radial direction of the disc-shaped information recording medium. Then, at each time of the measurement of the number of the record tracks of the present invention, the small amount of second record information, i.e. the smallest information unit, is reproduced and simultaneously deleted.

In this aspect, the judging device may control the reproducing device to reproduce the second record information in a predetermined order, and detects whether or not there is the second record information, on the basis of a reproduction signal obtained from the reproducing device.

By virtue of such construction, it is possible to detect whether or not there is the second record information, accurately and quickly, by reproducing and simultaneously deleting the second record information in the predetermined order, which is descending order from a large sector number to a small sector number, wherein the sector number indicates the address of the second record information.

Moreover, in this aspect, the predetermined order may be descending order from a large address to a small address.

By virtue of such construction, it is possible to detect whether or not there is the second record information, more accurately and quickly, by reproducing and simultaneously deleting the second record information in the predetermined order, which is the descending order from a large sector number to a small sector number, wherein the sector number indicates the address of the second record information. The reason is that when the address is searched for, usually, a smaller address than a target address is searched for, and then normal reproduction is performed, to thereby obtain the target address, so if the reproduction is performed in the descending order from the information unit having a large address (e.g. 1ECC block) to the information unit having a small address, the second record information recorded at a smaller address than the target address is always not deleted. In contrast, if the information unit is detected (checked) in ascending order from the information unit having a small address to the information unit having a large address, because of the reproduction, the second record information is likely almost or completely deleted. This causes such a trouble that the searching cannot be performed at the next time of detection (check).

In another aspect of the embodiment of the information reproducing apparatus of the present invention, the judging device detects whether or not there is the second record information, in order of logically reproducing the first record information, if judging whether or not the reproduction of the first record information is completed.

According to this aspect, it is judged whether or not the reproduction is completed, not from the Nth first record information in which the content of a final stage is recorded, but from the 1st first record information in which the content of the first stage is recorded, for example. That is to say, it is judged whether or not the reproduction is completed from the first stage, the second stage and the final stage. By this, it is possible to prevent that the second record information corresponding to the Nth first record information in which the content of the final stage is recorded and which is not completed until the end is completely deleted and used up, improperly, by the smallest information unit.

(Embodiment of Information Reproducing Method)

Hereinafter, the information reproducing method in an embodiment of the present invention will be explained.

An embodiment of the information recording method of the present invention is an information reproducing method in an information reproducing apparatus provided with: a reproducing device for reproducing the first and second record information recorded on the above-mentioned information recording medium of the present invention (including its various aspects), the information reproducing method provided with: a controlling process of controlling the reproducing device to reproduce the second record information corresponding to the first record information after reproduction of the first record information; and a judging process of detecting whether or not there is the second record information recorded in the number-of-times-of-reproduction limit area and of judging whether or not the reproduction of the first record information corresponding to the second record information is completed.

According to the embodiment of the information recording method of the present invention, as in the above-mentioned embodiment of the information recording apparatus of the present invention, for example, a user can certainly or easily judge until which level or which stage the reproduction of the content data is completed, for example.

Incidentally, even the embodiment of the information recording method of the present invention can adopt the same various aspects as those of the embodiment of the information recording apparatus of the present invention, as occasion demands.

These effects and other advantages of the present invention become more apparent from the following examples.

As explained above, according to the information recording medium of the present invention, it is provided with: a reproduce-only area in which first record information is recorded not to be unreproducible along with a reproduction operation; and a number-of-times-of-reproduction limit area in which second record information is recorded to be unreproducible along with a predetermined number of times of reproduction operations, the second record information being associated with the first record information. Thus, only by detecting whether or not there is the second record information, it is possible to judge whether or not the reproduction of the first record information is completed, and it is possible to judge the reproduction status of the information recording medium as a whole. According to the embodiment of the information reproducing apparatus of the present invention, it is provided with: the reproducing device; the controlling device; and the judging device, and according to the embodiment of the information reproducing method of the present invention, it is provided with: the reproducing device; the controlling process; and the judging process. Thus, only by detecting whether or not there is the second record information, it is possible to judge whether or not the reproduction of the first record information is completed, and it is possible to judge the reproduction status of the information recording medium as a whole.

Particularly, according to the embodiment of the information recording medium of the present invention, it is an information recording medium provided with: a reproduce-only area in which each of a plurality of first record information is recorded not to be unreproducible along with a reproduction operation; and a number-of-times-of-reproduction limit area in which each of a plurality of second record information is recorded to be unreproducible along with a predetermined number of times of reproduction operations, each of the plurality of second record information being associated with respective one of the plurality of first record information, each of the plurality of second record information including a plurality of smallest information units which can be reproduced and deleted by a discontinuous reproduction operation. Thus, only by detecting whether or not there is the second record information, it is possible to judge whether or not the reproduction of the first record information is completed, and it is possible to judge the reproduction status of the information recording medium as a whole. In addition, in one aspect of the embodiment of the information recording medium of the present invention, each of the plurality of second record information is recorded in a comprehensive partial area as one portion of the number-of-times-of-reproduction limit area, and each partial area is divided by the reproduce-only area. Thus, only by detecting whether or not there is the second record information, it is possible to judge whether or not the reproduction of the first record information is completed, and it is possible to judge the reproduction status of the information recording medium as a whole.

### EXAMPLES

### Information Recording Medium

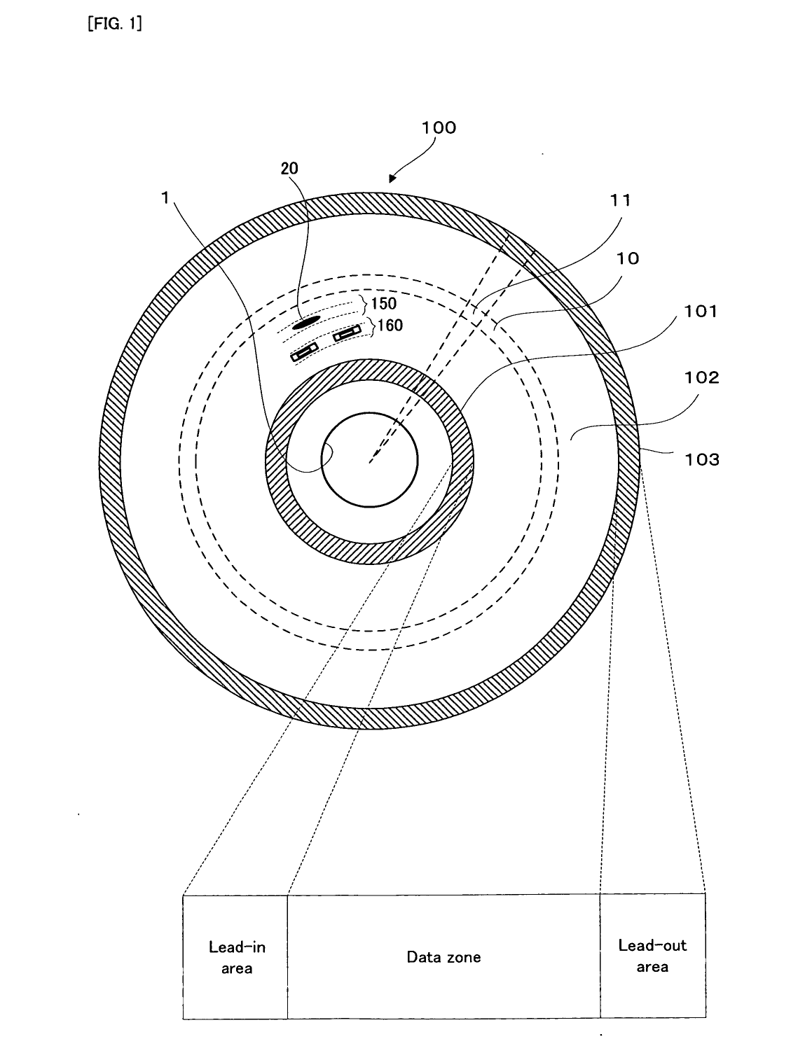

Next, with reference to FIG. 1 to FIG. 6, a detailed explanation will be given for the structure of recording areas and the physical characteristic of an optical disc in an example of the information recording medium of the present invention.

At first, with reference to FIG. 1, the basic structure of the optical disc in the example will be explained. FIG. 1 shows the basic structure of an optical disc in an example of the information recording medium of the present invention, wherein an upper part is a schematic plan view showing the optical disc having a plurality of recording areas and a lower part corresponding thereto is a schematic conceptual view showing a recording area structure in the radial direction.

As shown in FIG. 1, an optical disc 100 has a recording surface on a disc main body with a diameter of about 12 cm, as is a DVD. On the recording surface, the optical disc 100 is provided with: a lead-in area 101; a data zone 102; and a lead-out area 103, in the example, from the inner to the outer circumferential side, centered on a center hole 1. Then, in each recording area, a track or tracks 10, such as a groove track and a land track, are alternately placed, spirally or concentrically, with the center hole 1 as the center. Moreover, on the track 10, data is divided and recorded by a unit of ECC block 11. The ECC block 11 is a data management unit by a pre-format address in which record information is error-correctable. Incidentally, the optical disc 100 of the present invention does not necessarily have a single layer structure. It may be a two-layer single sided type, i.e., a dual layer type, or may be a two-layer double sided type, i.e., a dual layer double sided type.

The optical disc 100 in the example is constructed as a hybrid type optical disc having a combination of two types of recording areas divided from the viewpoint of the physical characteristic, more specifically, a combination of a number-of-times-of-reproduction limit area 150 and a reproduce-only area 160.

In the number-of-times-of-reproduction limit area 150, the record information (i.e. the “second record information” of the present invention) is recorded as a record mark, formed by a phase change in the recording layer, for example, and the record information can be reproduced by irradiating laser for reproduction only once or a limited certain number of times. Simultaneously, the record information is deleted by the reproduction, performed by irradiating the laser for reproduction only once or a limited certain number of times. Moreover, the record information can be recorded again, by irradiating laser for recording again, after the deletion.

On the other hand, in the reproduce-only area 160, the record information (i.e. the “first record information” of the present invention) is recorded as an embossed pit, for example, and there is provided the characteristic of a ROM type optical disc in which the record information can be reproduced physically any number of times, by irradiating the laser for reproduction. Incidentally, with regard to the arrangement of the number-of-times-of-reproduction limit area 150 and the reproduce-only area 160, they may be mixed by an extremely fine unit, such as every pit and every ECC block, for example, or they may be mixed by an extremely coarse unit, such as nearer the inner circumferential side and the outer circumferential side of the optical disc 100, for example.

As explained below, the recording area to record therein content information, such as video information and music information, shall be mainly the reproduce-only area 160, and at least one portion of the area to record therein information for controlling the reproduction of the content information shall be the number-of-times-of-reproduction limit area 150. Namely, by virtue of such construction, with respect to the optical disc 100 on which the reproduction cannot be performed any more after a predetermined number of times, if the information is recorded again only into the number-of-times-of-reproduction limit area 150, which occupies a relatively small area, it is possible to return the optical disc 100 to a reproducible condition again. Therefore, it is useful in terms of easy recycling. However, it is arbitrary to expand the area occupied by the number-of-times-of-reproduction limit area 150, and in an extreme case, the reproduce-only area 160 may be almost or completely eliminated, and only the number-of-times-of-reproduction limit area 150 may be almost or completely provided. Incidentally, the “record mark” in the example is a concept not only including the record mark supporting the record information in which the number of times of reproduction is limited (i.e. the “second record information” of the present invention), but also including a “dummy record mark” which does not allow information, such as NULL data, to have a meaning, in the number-of-times-of-reproduction limit area 150.

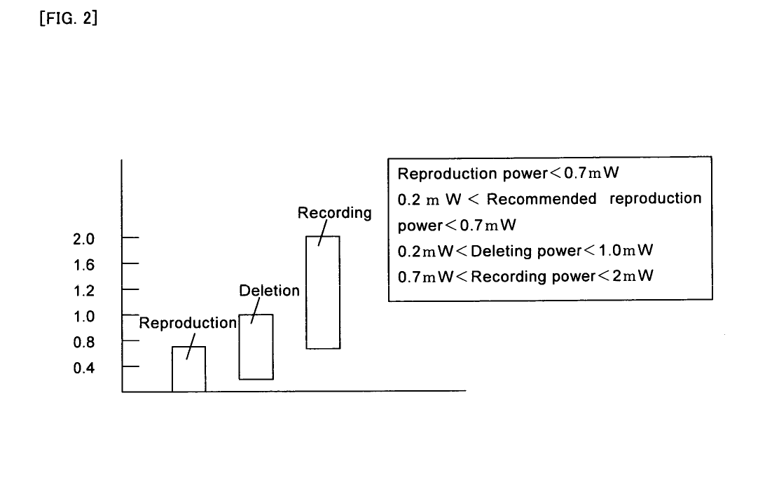

Next, with reference to FIG. 2, an explanation will be given for the physical characteristic of the recording layer, mainly in the number-of-times-of-reproduction limit area of the optical disc in the example of the present invention. The physical characteristic is, more specifically, a characteristic in which the record mark in which the record information is recorded, can be reproduced by irradiating the laser for reproduction, in the recording layer in the number-of-times-of-reproduction limit area. Here, FIG. 2 is a graph showing one specific example of a reproduction power range, a deleting power range, and a recording power range of a recording layer, in the number-of-times-of-reproduction limit area of the optical disc in the example of the present invention. In FIG. 2, the vertical axis indicates the value of the laser power by using a unit of mW (milliwatt), and the horizontal axis indicates the types of the laser of the optical disc in the example (the laser for reproduction, for deletion, and for recording, from the left, in FIG. 2).

The recording layer of the optical disc in the example of the present invention is formed such that the reproduction power range is 0.7 mW or less, as a general rule, as shown in FIG. 2. Moreover, in order to overlap the deleting power range and the reproduction power range, the recording layer may be formed such that the reproduction power range is 0.2 mW or more and 0.7 mW or less. The recording layer is formed such that the deleting power range is 0.2 mW or more and 1.0 mW or less, and the recording power range is 0.7 mW or more and 2.0 mW or less.

In this manner, in the optical disc in the example of the present invention, with regard to the number-of-times-of-reproduction limit area thereof, if the reproduction is performed by irradiating the laser with a power in a range of overlapping the reproduction power range and the deleting power range in the example, which is recommended when the reproduction is performed on reproduce-only media, such as a DVD-ROM, for example, as the laser for reproduction, then, it is possible to reproduce and simultaneously delete the record information. Incidentally, the record information may be deleted by once or several times of reproduction. From the viewpoint of the physical characteristic, by irradiating the laser for reproduction, it is possible to change a phase of the recording layer, from an amorphous state in which the record mark is formed and its reflectance is low, to a crystalline state in which the reflectance is high to some degree.

In particular, the reproduction power range and the deleting power range may be overlapped in a ratio of 50% or more, for example. Moreover, the deleting power range may include the reproduction power range.

Moreover, the recording power range of the recording layer of a commercially available rewritable type information recording medium, such as a DVD-R/W, or write-once type information recording medium, such as a DVD-R, and the recording power range of the recording layer of the optical disc in the example are not overlapped. Therefore, the writer of the commercially available rewritable type or write-once type information recording medium cannot perform the recording with respect to the optical disc in the example. Thus, it is possible to prevent the re-recording of the record information and illegal reproduction beyond the number of times of reproduction supposed to be limited, which is what the provider of the optical disc is not expecting to occur. On the other hand, the collector (e.g. the provider) of the optical disc can record the record information again by irradiating the laser for recording, as shown in FIG. 2, and reuse the optical disc.

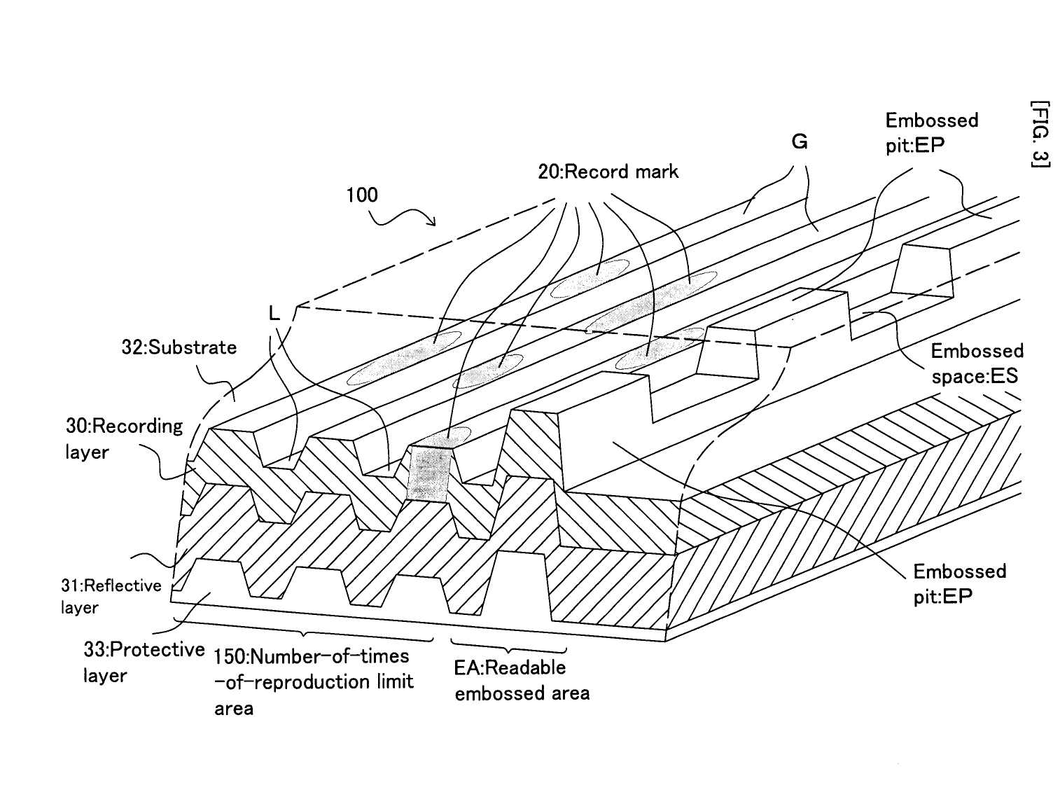

Next, with reference to FIG. 3, an explanation will be given for the detailed physical structure of a readable embossed area constituting one example of the reproduction-only area and the number-of-times-of-reproduction limit area of the optical disc in the example of the present invention. FIG. 3 is a schematic enlarged perspective view in which one portion of the optical disc in the example of the present invention is viewed from the recording surface side of the optical disc.

As shown in FIG. 3, the optical disc 100 in the example is provided with: a substrate 32; and a recording layer 30; a reflective layer 31; and a protective layer 33 laminated or stacked on the substrate 32. Incidentally, in addition to the layers, a dielectric layer or the like may be disposed in the upper part or the lower part of the recording layer 30. Alternatively, a cover substrate or the like may be bonded on the lower layer side of the protective layer 33 made of an adhesive layer or the like.

On the entire surface of the substrate 32 (the entire surface on the lower side, in FIG. 3), a groove track G and a land track L are formed by embossing or the like. On the groove track G in a readable embossed area EA, an embossed pit EP and an embossed space ES are formed by embossing. On the other hand, on the groove track G in the number-of-times-of-reproduction limit area 150, a record mark 20 is formed in the recording layer 30. The record mark 20 is constructed as a pit by a phase change (a pit made in black by the phase change), by irradiating the laser for recording. The reflective layer 31 is an Al (aluminum) film, for example, formed directly on the recording layer 30 film-formed the embossed substrate 32, or formed through a not-illustrated dielectric layer or insulating layer.

The optical disc 100 is constructed as a kind of phase change type disc provided with the recording layer 30, with regard to the number-of-times-of-reproduction limit area 150. By forming the record mark 20 in one portion of the recording layer 30, the data is recorded such that it can be deleted and reproduced. More specifically, the recording layer 30 in the crystalline state with a large reflectance is irradiated with a laser beam, so that the recording layer 30 is partially melted and cooled rapidly. By this, the recording layer 30 is partially in the amorphous state, so that the reflectance can be reduced. In one portion of the recording layer 30 in the amorphous state as described above, the record mark 20 is formed. On the other hand, the recording layer 30 in the amorphous state is irradiated with a laser beam, so that the recording layer 30 is partially melted and cooled slowly. By this, the recording layer 30 is returned to the crystalline state, to thereby regain the large reflectance. Namely, the data can be deleted.

On the other hand, the optical disc 100 is constructed as a kind of ROM type disc provided with the embossed pit EP, independently of the presence of the recording layer 30, with regard to the readable embossed area EA. More specifically, on the substrate 32 made of polycarbonate, the groove track G is formed as a track for guide, to lead a beam, such as laser light. Incidentally, in the substrate 32, an area between adjacent groove tracks G is referred to as the land track L. It is additionally added, with regard to the names of the groove track G and the land track L, that a concave portion as viewed from the substrate 32 as a base is referred to as the groove track G, and a convex portion is referred to as the land track L. Namely, as seen from the optical pickup side (i.e. the upper side in FIG. 3), a groove corresponds to the convex portion, and a land corresponds to the concave portion.

As described above, in the example, the optical disc 100 is constructed as a kind of phase change type disc with regard to the number-of-times-of-reproduction limit area 150, and is constructed as a kind of ROM type disc with regard to the readable embossed area EA which is one example of the reproduce-only area. Then, the optical disc 100 is constructed as the hybrid type disc as a whole. Incidentally, in the example, the same recording layer 30 as that of the number-of-times-of-reproduction limit area 150 may be formed in the readable embossed area EA, and the same recording film as that of the number-of-times-of-reproduction limit area 150 may be deposited in the readable embossed area EA. With regard to the recording layer 30 formed in the readable embossed area EA as described above, if the information is not recorded by the phase change, the presence of the recording layer 30 does not adversely influence the reproduction of the embossed pit EP. On the contrary, if the recording layer 30 is formed even in the readable embossed area EA as described above, by film-forming the recording layer 30 on the entire surface of the substrate 32, it is not necessary to subsequently remove or exfoliate the recording layer 30 or the like, partially, so that it is useful in manufacturing. Even in this case, it is equivalent to a deletion mode of a constant amount of light, so that the record mark 20 is not prepared and there is no trouble.

In particular, this is not illustrated in FIG. 3 for convenience, but on the optical disc 100, the groove track G is preferably wobbled with a frequency corresponding to the rotational speed of the disc. The wobbled groove track G is formed before the optical disc 100 is shipped, as in a land pre-pit, described later. Then, when the record information, i.e. information, such as image information, to be originally recorded other than pre-information, is recorded onto the optical disc 100, the optical disc 100 may be rotation-controlled at a predetermined rotational speed, by extracting the wobbling frequency of the groove track G by using an information recording/reproducing apparatus described later.

Moreover, particularly, the not-illustrated land pre-pit corresponding to the pre-information may be formed in the land track L. This land pre-pit is formed generally before the optical disc 100 is shipped. Moreover, the pre-information is obtained in advance by detecting the land pre-pit, and on the basis of the pre-information obtained, the optimum output or the like of the laser light as recording light is set. At the same time, address information or the like which indicates a location on the optical disc 100 where the record information is to be recorded, is obtained, and on the basis of the address information, the record information is recorded in a corresponding recording position.

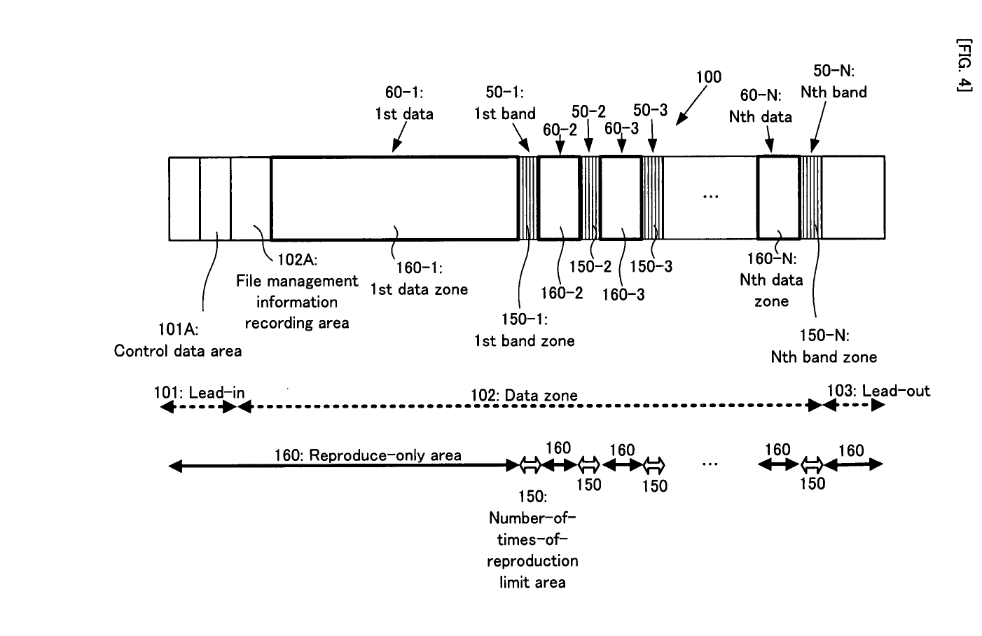

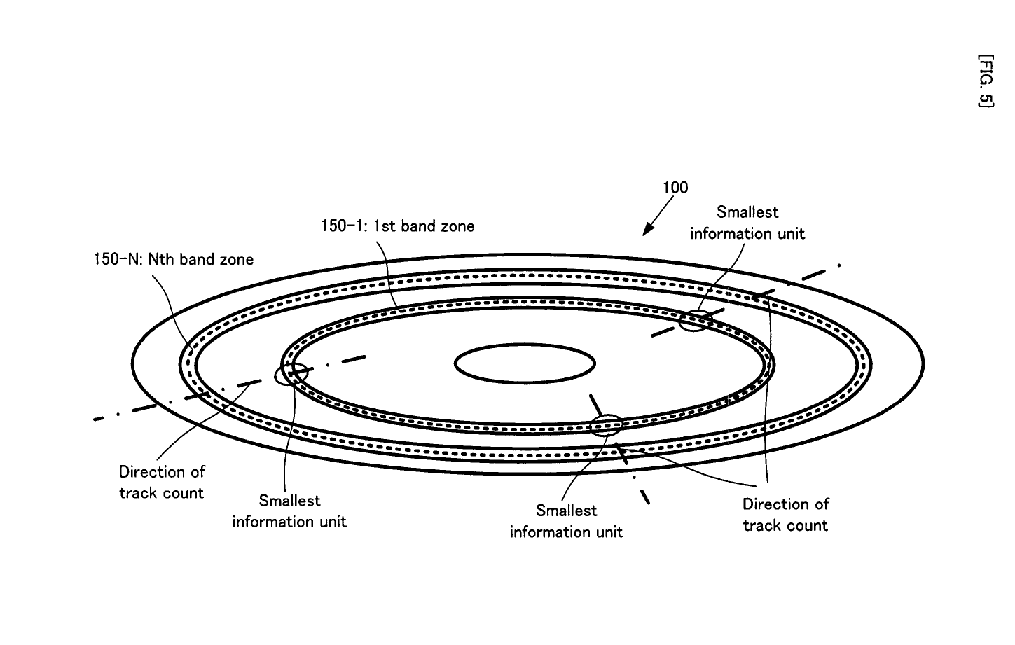

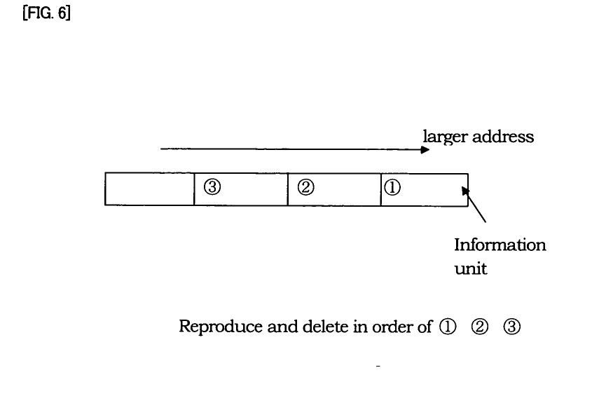

Next, with reference to FIG. 4 to FIG. 6, an explanation will be given for the structure of the recording areas, such as the reproduce-only area and the number-of-times-of-reproduction limit area, of the optical disc in the example of the present invention, and the information and data recorded in the recording areas. FIG. 4 is a schematic structure diagram showing the structure of the recording areas, the reproduce-only area, and the number-of-times-of-reproduction limit area, of the optical disc in the example of the present invention. Incidentally, the left side in FIG. 4 is the inner circumferential side of the optical disc, and the right side in FIG. 4 is the outer circumferential side of the optical disc. FIG. 5 is an appearance perspective view showing a direction of a track count on the recording surface of the optical disc in the example of the present invention. FIG. 6 is a conceptual view showing the state of second record information recorded in the number-of-times-of-reproduction limit area in another example of the present invention.

At first, as shown in FIG. 4, there is the lead-in area 101 on the most inner circumferential side of the recording areas of the optical disc 100, and there is adjacently the data zone 102 on the outer circumferential side of the lead-in area 101, and there is adjacently the lead-out area 103 on the outer circumferential side of the data zone 102.

In the lead-in area 101 and the lead-out area 103, there are recorded various information, such as control information or management information, for example, for controlling or managing the recording and reproduction of the data. The “data” in the example herein is data which is a main target of the reproduction or execution, and is content data, such as image data, audio data, and text data, for example, and data for a computer program or the like. The control information is information for controlling the recording and reproduction with respect to the data zone 102, and is information which indicates the attribute and the type of the information recording medium, information for address management of the data, and information for controlling the recording and reproduction operations of the information recording/reproducing apparatus, such as a disc drive, for example, or the like. On the outer circumferential side of the inside of the lead-in area 101, there is provided a control data area 101A. The control data area 101A is an area to record therein the control information for controlling the recording and reading with respect to the data zone 102.

In the data zone 102, the above-mentioned data or user data is recorded. The data zone 102 is a main area to record therein the data. More specifically, from the inner to the outer circumferential side of the inside of the data zone 102, there are provided: a file management information recording area 102A; a 1st data zone and a 1st band zone; a 2nd data zone and a 2nd band zone; . . . ; and an Nth data zone and an Nth band zone. In the file management information recording area 102A, a file system or space bit map information which indicates a recorded or unrecorded condition in each logical or physical block of the recording areas, or the like is recorded. The 1st data zone and the 1st band zone; the 2nd data zone and the 2nd band zone; . . . ; and the Nth data zone and the Nth band zone will be described in detail later.

The control information and the management information, and the data, recorded on the information recording medium, cannot be always clearly distinguished in accordance with the content thereof. However, the control information and the management information are mainly information directly used for the operation control of the information recording/reproducing apparatus, such as a disc drive, for example. In contrast, the data is mainly data which is merely a recording or reproduction target, and is data mainly used in a data reproduction process or program execution process of a back end or a host computer, for example. In accordance with a difference in such characteristics or the like, the data is recorded in the data zone 102, and the control information and the management information are recorded in the control data area 101A within the lead-in area 101, the lead-out area 104, or the file management information recording area 102A within the data zone 102.

At first, the file management information recording area 102A within the data zone 102, the lead-in area 101, and the entire area within the lead-out area 103 are constructed as the reproduce-only area 160 in which the embossed pit is formed, and in these areas, there is recorded the user data, which constitutes one example of the “first record information” of the present invention, or the like.

Then, particularly in the example, a 1st band zone 150-1 to an Nth band zone 150-N within the data zone 102 are constructed as the number-of-times-of-reproduction limit area 150 in which the record mark is formed, for example. In the 1st band zone 150-1 to the Nth band zone 150-N, a 1st band 50-1 to an Nth band 50-N (N is a natural number of 2 or more), which constitute one example of the “second record information” of the present invention, are recorded, respectively, by the formation of the record mark in the recording layer. The 1st band 50-1 to the Nth band 50-N may be dummy record information which does not have information, such as NULL data, for example. Alternatively, they may be data record information for display on a display panel of characters, patterns, and the image information, such as the image which indicates a diploma or which indicates screen of clearing or finishing a stage of a game, and for playback of music. In the latter case, the 1st band 50-1 to the Nth band 50-N can be deleted at the same time that music is played, so that it is possible to save time.

On the other hand, a 1st data zone 160-1 to an Nth data zone 160-N within the data zone 102 are constructed as the reproduce-only area 160 in which the embossed pit is formed, for example. In the 1st data zone 160-1 to the Nth data zone 160-N, 1st data 60-1 to Nth data 60-N, which constitute one example of the “first record information” of the present invention, are recorded, respectively, by the formation of the embossed pit. If applied to contents for education, the 1st data 60-1 to the Nth data 60-N may be content data adjusted for a leaning stage, such as beginner, intermediate, and advanced, for example. Alternatively, if applied to a disc on which a home-use game for a personal computer is recorded, they may be also content data corresponding to a hierarchical level of progress of the game, such as a 1st, 2nd, . . . , and Nth stage, for example.

In the example, particularly, each of the 1st band 50-1 to the Nth band 50-N respectively recorded in the 1st band zone 150-1 to the Nth band zone 150-N is logically or physically associated with respective one of the 1st data 60-1 to the Nth data 60-N. The logical association herein is to associate the data zone (160-1 etc.) in which the data (60-1 etc.) is recorded, with the band zone (150-1 etc.) in which the band (50-1 etc.) corresponding to the data (60-1 etc.) is recorded, on the basis of a logical address allocated or assigned in the both areas, in the reproduction and the recording. Specifically, a table on which identification numbers of the 1st data 60-1 to the Nth data 60-N and the addresses of the 1st data zone 160-1 to the Nth data zone 160-N are registered, or the like, are registered or recorded in the management information or the like. On the other hand, a table on which identification numbers of the 1st band 50-1 to the Nth band 50-N and the addresses of the 1st band zone 150-1 to the Nth band zone 150-N are registered, or the like, are registered or recorded in the same management information or the like. Thus, each of the 1st band 50-1 to the Nth band 50-N can be logically associated with respective one of the 1st data 60-1 to the Nth data 60-N. Alternatively, a table on which identification numbers of the 1st data zone 160-1 to the Nth data zone 160-N and the addresses thereof are registered, or the like, are registered or recorded in the management information or the like. On the other hand, a table on which identification numbers of the 1st band zone 150-1 to the Nth band zone 150-N and the addresses thereof are registered, or the like, are registered or recorded in the management information or the like. Thus, each of the 1st band zone 150-1 to the Nth band zone 150-N in which the 1st band 50-1 to the Nth band 50-N are respectively recorded can be logically associated with respective one of the 1st data zone 160-1 to the Nth data zone 160-N in which the 1st data 60-1 to the Nth data 60-N are respectively recorded.

On the other hand, the physical association herein is to associate the data zone area in which one of the plurality of data is recorded, with the band zone area in which the band corresponding to the data is recorded, on the basis of the physical structure of the recording areas, in the reproduction and the recording. Specifically, if the band zone is specified in accordance with a certain rule, such as in front of the start portion or behind the end portion of the 1st data zone 160-1 is the 1st band zone 150-1, in front of the start portion or behind the end portion of the 2nd data zone 160-2 is the 2nd band zone 150-2, and in front of the start portion or behind the end portion of the Nth data zone 160-N is the Nth band zone 150-N, then, it is possible to specify the data zone physically corresponding to the band zone. Thus, each of the 1st band 50-1 to the Nth band 50-N can be physically associated with respective one of the 1st data 60-1 to the Nth data 60-N.

In any case of the above-mentioned logical or physical association, one of the plurality of bands, e.g. the 1st band, is associated with which one of the plurality of data, e.g. the 1st data, is registered or recorded in the management information or a memory in an information recording apparatus, for example, and it is known upon the reproduction of the 1st data, for example.

Moreover, particularly in the example, each of the plurality of bands (50-1 etc.) includes a plurality of smallest information units which can be reproduced and deleted by a discontinuous reproduction operation. The “discontinuous reproduction operation” herein indicates an operation of performing the reproduction while the laser light for reproduction is displaced in a direction of crossing the track perpendicularly. Moreover, the “smallest information unit” herein indicates a small size of constituent unit of the plurality of bands (50-1 etc.) which can be reproduced and deleted. More specifically, it is a small size of the 1st band 50-1 recorded in a micro domain of the 1st band zone 150-1, for example, which is irradiated with the laser for reproduction, not along the normal direction of the track as shown in FIG. 5, but in the direction of crossing the track perpendicularly, i.e. in the radial direction of the optical disc 100. Then, at each time of the measurement of the “number of the record tracks” of the present invention, this smallest information unit is reproduced and simultaneously deleted.

By virtue of the above-mentioned construction, upon the reproduction of the information recording medium, if the reproduction of one of the plurality of data (60-1 etc.) is completed, the band (50-1 etc.) associated with the data (60-1 etc.) cannot be reproduced along with the continuous reproduction operation, namely, it is reproduced and simultaneously deleted. For example, if the reproduction of the 1st data 60-1 recorded in the 1st data zone is completed, which is the content data of a first stage of a home-use game for a personal computer, the 1st band 50-1 recorded in the 1st band zone, logically or physically associated with the 1st data 60-1, cannot be reproduced along with the continuous reproduction operation.

In particular, the 1st band 50-1 includes the plurality of smallest information units which can be reproduced and deleted by the discontinuous reproduction operation. Thus, at the time of continuous reproduction or next time the disc is inserted or loaded, because only a small amount of the 1st band 50-1 recorded in the 1st band zone 150-1, i.e. the smallest information unit, cannot be reproduced by the discontinuous reproduction operation, such as track jump or scanning, it is detected that the 1st band 50-1 does not exist. By this, it is possible to judge that the reproduction of the 1st data 60-1, which is the content data of the first stage, for example, is completed.

Moreover, it is detected that the 2nd band 50-2 exists, by reproducing the smallest information unit of the 2nd band 50-2 recorded in the 2nd band zone 150-2 by the discontinuous reproduction operation, such as track jump, for example. By this, it is possible to judge that the reproduction of the 2nd data 60-2, which is the content data of the second stage, for example, recorded in the 2nd data zone 160-2, is not completed yet.

Then, it turns out that it is necessary to start the reproduction from the 2nd data 60-2, which is the content data of the second stage, for example. In the same manner, the reproduction process can be performed up to the Nth data 60-N which is the content data of the Nth stage.

As described above, the presence or absence of the 1st band 50-1 to the Nth band 50-N detected upon the reproduction of the optical disc 100, functions as a binarized flag for indicating whether or not the reproduction of the 1st data 60-1 to the Nth data 60-N is completed. Thus, while the number of times of reproduction is limited, it is possible to relatively easily detect or judge whether or not the reproduction of the 1st data 60-1 to the Nth data 60-N is completed, on the information reproducing apparatus. Therefore, a user can certainly or easily judge until which level or which stage the reproduction of the content data is completed, for example.

Moreover, in the example, particularly, the 1st data zone 160-1 to the Nth data zone 160-N in which the 1st data 60-1 to the Nth data 60-N are respectively recorded, and the 1st band zone 150-1 to the Nth band zone 150-N in which the 1st band 50-1 to the Nth band 50-N are respectively recorded, may be alternately located from the inner to the outer circumferential side, basically, in accordance with the order of reproduction of the 1st data 60-1 to the Nth data 60-N, for example, on the basis of temporal or timing locality/spatial locality in the operation of an optical pickup or the like. Therefore, the data closer to the Nth data 60-N which has a high possibility of noncompletion until the end of the completion of reproduction of the optical disc 100, has less opportunities of irradiating the laser for reproduction by the track jump, to judge whether or not the stage is completed. Thus, it is possible to prevent such a situation that the Nth data 60-N, the Nth band 50-N, which has a high possibility of noncompletion until the end, and data closer thereto, are unnecessarily irradiated with the laser for reproduction. By which, it is possible to prevent such a situation that the Nth data 60-N, the Nth band 50-N, and data closer thereto are used up as flags, before the completion of reproduction of the optical disc 100. They can be arbitrarily disposed, according to the application and purpose of the 1st data 60-1 to the Nth data 60-N.

In addition, according to the example, a relatively large amount of data (60-1 etc.) is maintained as it is. Thus, after only by once judging the completion of reproduction and judging that the reproduction cannot be performed, recording again a relatively small amount of band (50-1 etc.) by the collector or the like, it is possible to normally reproduce again the 1st data 60-1 to the Nth data 60-N, such as content data, recorded on the optical disc 100, with a normal optical disc player or optical disc recorder, at each hierarchical level. Thus, it is possible to reuse the information recording medium as a whole, extremely efficiently.

Moreover, in the example, considering the characteristic that the recording is performed a plurality of times in the 1st band zone 150-1 to the Nth band zone 150-N, it is preferable that the groove exists. On the other hand, in the example, each of the 1st band zone 150-1 to the Nth band zone 150-N are 10 tracks, for example. Thus, considering that a discontinuous, somewhat small amount of data is recorded, it is preferable that the groove does not exist.

Incidentally, in the example, it is detected (checked) whether or not there is the second record information, such as the 1st band 50-1, recorded in the number-of-times-of-reproduction limit area 150, by the discontinuous reproduction operation, by using a reproducing device, such as an optical disc, described later, and a judging device, such as a CPU, for example. However, as shown in FIG. 6, the second record information can be reproduced in descending order from an information unit (e.g. 1 ECC block) having a large address, such as a sector, to an information unit having a small address, and on the basis of the reproduction signal, it is possible to detect whether or not there is the second record information. More specifically, when the second information unit is firstly detected (checked), the information unit shown by a “circle (1)” in FIG. 6 is desirably searched to detect whether or not there is the second record information, and then, when the second information unit is detected (checked), the information unit shown by a “circle (2)” in FIG. 6 is desirably searched to detect whether or not there is the second record information. The reason is that when the address is searched for, usually, a smaller address than a target address is searched for, and then normal reproduction is performed, to thereby obtain the target address, so if the reproduction is performed in descending order from the information unit having a large address (e.g. 1ECC block) to the information unit having a small address, the second record information recorded at a smaller address than the target address is always not deleted. In contrast, if the information unit is detected (checked) in ascending order from the information unit having a small address to the information unit having a large address, because of the reproduction, the second record information is likely almost or completely deleted. This causes such a trouble that the searching cannot be performed at the next time of detection (check).

(Information Reproducing Apparatus)

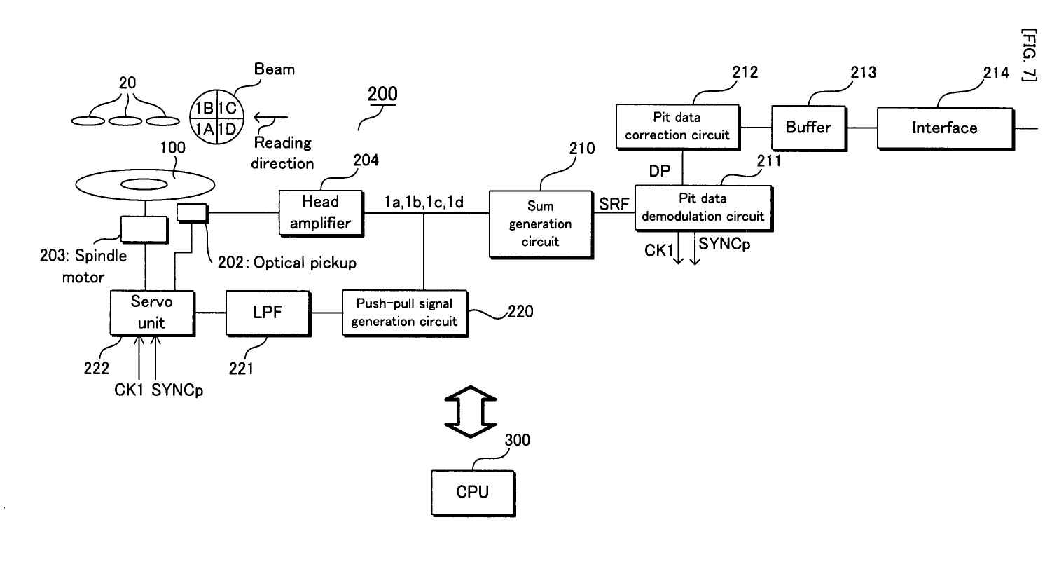

Next, with reference to FIG. 7, the information reproducing apparatus for the optical disc in an example of the present invention will be discussed. FIG. 7 is a block diagram showing the entire structure of the information reproducing apparatus for the optical disc, in the example of the present invention.

An information reproducing apparatus 200 is provided with: the optical disc 100; an optical pickup 202 which constitutes one example of the “reproducing device” of the present invention; a spindle motor 203; a head amplifier 204; a sum generation circuit 210; a pit data demodulation circuit 211; a pit data correction circuit 212; a buffer 213; an interface 214; a push-pull signal generation circuit 220; a low pass filter 221; a servo unit 222; and a CPU (Central Processing Unit) 300 which constitutes one example of the “controlling device” and the “judging device” of the present invention.

On the optical disc 100, pit data DP synchronized with a first clock signal CK1 is recorded by the length of a record mark 20. The first clock signal CK1 of a RF reproduction signal component is a signal which can be generated by the information reproducing apparatus 200 from the RF reproduction signal component of the optical disc 100 which varies in an almost constant cycle, in accordance with the wobbling, an unreadable emboss, or the like, as explained in the various examples of the optical disc 100 described above. In this example, the first clock signal CK1 is generated by the pit data demodulation circuit 211. Incidentally, in the example, the record mark 20 can be interpreted as a pit, and the track is constructed from this pit row.

More specifically, the information reproducing apparatus 200 is provided with: the optical pickup 202 for irradiating the optical disc 100 with a reproduction beam and outputting a signal in response to reflected light; the spindle motor 203 for controlling the rotation of the optical disc 100; and the servo unit 222. The first clock signal CK1 and a pit synchronization signal SYNCp are supplied to the servo unit 222. The servo unit 222 is synchronized with these signals, and performs spindle servo for controlling the rotation of the spindle motor 203, and focus servo and tracking servo for performing relative position control of the optical pickup 202 to the optical disc 100.

The optical pickup 202 is provided with a laser diode for irradiating the reproduction beam; and a not-illustrated four-division detection circuit. The four-division detection circuit divides the reflected light of the reproduction beam into four areas 1A, 1B, 1C, and 1D shown in the upper part of FIG. 7, and outputs each signal corresponding to the quantity of light in respective one of the areas. The head amplifier 204 amplifies each output signal of the optical pickup 202, and outputs a divisional read signal 1a corresponding to the area 1A, a divisional read signal 1b corresponding to the area 1B, a divisional read signal 1c corresponding to the area 1C, and a divisional read signal 1d corresponding to the area 1D.

The sum generation circuit 210 is provided with an addition circuit for adding the divisional read signals 1a, 1b, 1c, and 1d and for outputting a sum read signal SRF. Incidentally, the sum read signal SRF is a signal which represents the length of the record mark.

The pit data demodulation circuit 211 reproduces the pit data DP on the basis of the sum read signal SRF, and generates the first clock signal CK1. More specifically, the pit data demodulation circuit 211 demodulates the reproduced pit data DP by using a predetermined table, with the pit synchronization signal SYNCp as a reference position, to thereby generate reproduction data. For example, if EFM modulation is adopted as a modulating method, a process of converting 14-bit pit data DP to 8-bit reproduction data is performed. Then, a descramble process is performed in which the order of the reproduction data is rearranged in accordance with a predetermined rule, and the processed reproduction data is outputted.

The reproduction data obtained in this manner is supplied to the pit data correction circuit 212, on which an error correction process and an interpolation process are performed, and then, it is stored into the buffer 213. The interface 214 sequentially reads the data stored in the buffer 213, converts it in a predetermined output format, and outputs it to external equipment.

The push-pull signal generation circuit 220 calculates (1a+1d)−(1b+1c) and generates a push-pull signal. The component (1a+1d) corresponds to the areas 1A and 1D which are on the left side with respect to the reading direction, while the component (1b+1c) corresponds to the areas 1B and 1C which are on the right side with respect to the reading direction. The value of the push-pull signal indicates a relative position relationship between the reproduction beam and the track.

The push-pull signal is outputted to the servo unit 222 through the low pass filter 221. The servo unit 222 performs the tracking control on the basis of the push-pull signal.

The CPU 300 is connected through a not-illustrated bus or the like, and controls the entire information reproducing apparatus 200 by giving an instruction to each circuit or device or the like. Normally, software for operating the CPU 300 is stored in a not-illustrated memory or the like.

(Flow of Reproduction Operation by Information Reproducing Apparatus)

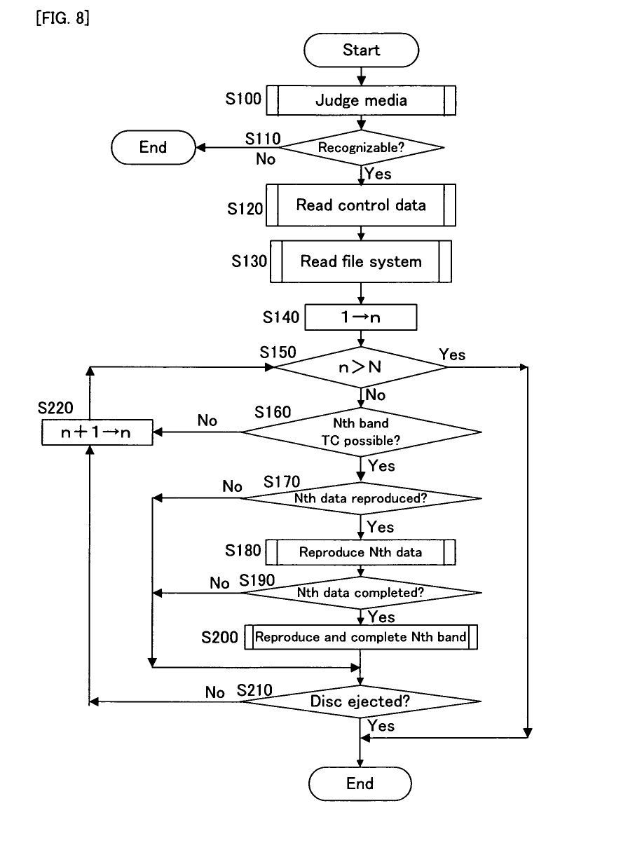

Next, with reference to FIG. 8, a flow of the reproduction operation performed by the information reproducing apparatus for the optical disc in the example of the present invention will be discussed.

At first, with reference to FIG. 8, the flow of the reproduction operation of the optical disc in the example of the present invention will be discussed. FIG. 8 is a flowchart showing the reproduction operation of the optical disc by the information reproducing apparatus in the example of the present invention.

At first, as shown in FIG. 8, when the information reproducing apparatus is in a play mode, the type of the optical disc is judged, such as a CD, a DVD-Video, a DVD-ROM, a DVD-R, or a DVD-RW (step S100). Incidentally, it is assumed that an optical disc in a DVD format (video) associated with the example of the present invention is inserted or loaded.

Then, it is judged whether or not the record information or the like can be recognized (step S110). Here, if the record information or the like can be recognized (the step S110: Yes), the control data is read, and basic information necessary for the reproduction operation is read (step S120).

On the other hand, as a result of the judgment in the step S110, if the record information or the like cannot be recognized (the step S110: No), the reproduction operation performed by the information reproducing apparatus is ended.

Then, the file system is read from the file management information recording area (step S130).

Then, “1” is substituted into a variable “n” (step S140).

Then, it is judged whether or not the variable “n” is larger than a constant “N” (step S150). The constant “N” is a natural number. Here, if the variable “n” is not larger than the constant “N”, i.e. if the variable “n” is equal to or less than the constant “N” (the step S150: No), it is detected from the measurement of the number of tracks (hereinafter referred to as “TC: Track Count”, as occasion demands) whether or not the 1st band is recorded in the 1st band zone, i.e. whether or not there are a predetermined number of tracks recorded in the 1st band zone (step S160). Here, if there are the predetermined number of tracks (the step S160: Yes), then, the 1st band is recorded in the 1st band zone, which means that the reproduction of the 1st data logically or physically associated with the 1st band is not completed yet, so that it is judged whether or not the 1st data is to be reproduced (step S170). Specifically, if this is applied to a disc on which a home-use game for a personal computer is recorded, it is judged whether or not the 1st data, which is the content data corresponding to the hierarchical level of the first stage, is to be reproduced. Here, if the 1st data is to be reproduced (the step S170: Yes), then, the reproduction of the 1st data is started (step S180).

Then, it is judged whether or not the reproduction of the 1st data is completed (step S190). Here, if the reproduction of the 1st data is completed (the step S190: Yes), the 1st band recorded in the 1st band zone logically or physically associated with the 1st data is reproduced and simultaneously deleted (step S200).

On the other hand, if the 1st data is not to be reproduced as a result of the judgment in the step S170 (the step S170: No), if the reproduction of the 1st data is not completed yet as a result of the judgment in the step S190 (the step S190: No), and if the 1st band is reproduced and simultaneously deleted in the step S200, it is judged whether or not the disc is to be ejected (step S210). Here, if the disc is to be ejected (the step S210: Yes), a series of reproduction operation performed by the information reproducing apparatus is ended.

The subsequent process is a loop from n=“2” to “N”, i.e. a repetitive process.

Namely, if there are not any predetermined number of tracks (the step S160: No), the variable “n” is added or incremented only by “1”, in order to perform the track count with respect to the next band (step S220). For example, if there are not any predetermined number of tracks in the 1st band, then, the 1st band is not recorded in the 1st band zone, which means the reproduction of the 1st data logically or physically associated with the 1st band is completed, so that the variable “n” is added or incremented only by “1”, in order to perform the track count with respect to the 2nd band, and n=1+1=2 (the step S220).

In the same manner, even if the disc is not to be ejected (the step S210: No), the variable “n” is added or incremented only by “1”, in order to perform the track count with respect to the next band (the step S220).

Then, it is judged whether or not the variable “n” is larger than the constant “N” (the step S150). Here, if the variable “n” is not larger than the constant “N” (the step S150: No), then, the processes after the step S160 are repeated.

On the other hand, if the variable “n” is larger than the constant “N” (the step S150: Yes), then, a series of reproduction operation performed by the information reproducing apparatus is ended.

The present invention is not limited to the above-described examples, and various changes may be made, if desired, without departing from the essence or spirit of the invention which can be read from the claims and the entire specification. An information recording medium, an information reproducing apparatus, and an information reproducing method, which involve such changes, are also intended to be within the technical scope of the present invention.

### INDUSTRIAL APPLICABILITY

The information recording medium, the information reproducing apparatus, and the information reproducing method of the present invention can be applied to an information recording medium, such as an optical disc, on which recording and reproduction can be performed by irradiating it with laser light, for example, and an information reproducing apparatus for and an information reproducing method of performing the reproduction on such an information recording medium.

1-11. (canceled)

12. An information recording medium comprising:
a reproduce-only area in which first record information is recorded not to be unreproducible along with a reproduction operation; and
a number-of-times-of-reproduction limit area in which second record information is recorded to be unreproducible along with a predetermined number of times of reproduction operations,
the second record information being associated with the first record information, information which indicates association of the second record information and the first record information being recorded in said reproduce-only area.

13. The information recording medium according to claim 12, wherein the second record information includes content information which is reproduced after reproduction of the first record information.

14. An information reproducing apparatus for reproducing the first and second record information recorded on the information recording medium according to claim 12,
said information reproducing apparatus comprising:
a reproducing device for reproducing the first and second record information;
a controlling device for controlling said reproducing device to reproduce the second record information associated with the first record information after reproduction of the first record information; and
a judging device for detecting whether or not there is the second record information recorded in said number-of-times-of-reproduction limit area and for judging whether or not reproduction of the first record information corresponding to the second record information is completed.

15. The information reproducing apparatus according to claim 14, wherein said judging device controls said reproducing device to displace laser for reproduction in a direction of crossing a record track in said number-of-times-of-reproduction limit area, and detects whether or not there is the second record information, on the basis of a reproduction signal obtained from said reproducing device within a time length in which the laser for reproduction is displaced.

16. The information reproducing apparatus according to claim 15, wherein said judging device detects whether or not there is the second record information, on the basis of the number of the record tracks crossed when said reproducing device is displaced.

17. The information reproducing apparatus according to claim 14, wherein said judging device controls said reproducing device to reproduce the second record information in a predetermined order, and detects whether or not there is the second record information, on the basis of a reproduction signal obtained from said reproducing device.

18. The information reproducing apparatus according to claim 17, wherein the predetermined order is descending order from a large address to a small address.

19. The information reproducing apparatus according to claim 14, wherein said judging device detects whether or not there is the second record information, in order of logically reproducing the first record information, if judging whether or not the reproduction of the first record information is completed.

20. An information reproducing method in an information reproducing apparatus comprising: a reproducing device for reproducing the first and second record information recorded on the information recording medium according to claim 12,
said information reproducing method comprising:
a controlling process of controlling said reproducing device to reproduce the second record information corresponding to the first record information after reproduction of the first record information; and
a judging process of detecting whether or not there is the second record information recorded in said number-of-times-of-reproduction limit area and of judging whether or not the reproduction of the first record information corresponding to the second record information is completed.

21. The information reproducing apparatus according to claim 12, wherein said information recording medium comprises a plurality of number-of-times-of-reproduction limit areas, and each of a plurality of said reproduce-only area is disposed between the plurality of number-of-times-of-reproduction limit areas.
